(19) United States
(12) Patent Application Publication
(10) Pub. No.: US 2004/0083471 A1
(43) Pub. Date: Apr. 29, 2004

(54) Method of upgrading system software of a home appliance

(75) Inventors: Youn Ho Nam, Seoul (KR); Young Hoon Cho, Seoul (KR)

Correspondence Address: Jonathan V. Kang, Esq., Lee & Hong, P.C., 14th Floor, 807 South Figueroa Street, Los Angeles, CA, 90017, US

(73) Assignee: LG Electronics Inc.

(21) Appl. No.: 10/687,901

(22) Filed: Oct. 17, 2003

(30) Foreign Application Priority Data
Oct. 21, 2002 (KR) 10-2002-64272
Oct. 22, 2002 (KR) 10-2002-64444

(51) Int. Cl. G06F 9/44

(52) U.S. Cl. 717/168; 717/171

(57) ABSTRACT

A method of upgrading system software of a home appliance, includes reading a system software version of the home appliance to be upgraded among home appliances constituting a home network with a home server, reading a latest system software version corresponding to the home appliance from an appliance company server connected through the home server and Internet, comparing the system software version of the home appliance in the home network with the system software version of the corresponding home appliance in the appliance company server, if the system software version of the corresponding home appliance in the appliance company server is newer than the system software version of the home appliance in the home network, downloading the system software of the corresponding home appliance from the appliance company server to the home server, and replacing the system software of the home appliance at home with the downloaded system software through the home network.

This application claims the benefit of the Korean Application Nos. P2002-64272 and P2002-64444 filed on Oct. 21, 2003 and Oct. 22, 2003, respectively, which are hereby incorporated by reference.

### BACKGROUND OF THE INVENTION

1. Field of the Invention

The present invention relates to a method of upgrading a home appliance by downloading the latest system software of the home appliance using a home server.

2. Desciption of the Related Art

Generally, home appliances recently produced have diverse functions suitable for the multimedia generation. Such home appliances, in distinction from the past classic home appliances, implement the diverse functions through replaceable system software.

Recently, with the increase of memory capacity and the development of micro technology, various kinds of home appliances can operate with high-level functions. For this, a flash memory for storing therein various kinds of programs is installed in a home appliance. If a specified signal is inputted by a user's manipulation, a CPU of the home appliance calls the corresponding program from the flash memory, and performs a specified function corresponding to the program.

Meanwhile, various kinds of programs related to the operation of the home appliance are stored in the flash memory built in the home appliance, and the operation of the home appliance is controlled by the programs. An upgrade of the home appliance can be performed by replacing the stored programs with new system software.

Specifically, in order to upgrade the system software so as to provide a new function or change or improve the existing function, the existing system software stored in the flash memory of the home appliance should be replaced with new system software.

In the related art, in order to upgrade the home appliance through replacement of the system software, an after-sales service man belonging to a home appliance company or a designated service-providing company should visit a user's home.

FIG. 1 is a schematic view illustrating a related art system for implementing a method of upgrading system software of a home appliance.

As illustrated in FIG. 1, the user accesses a server 120 of a company which manufactured the home appliance, for example, a television receiver 100, through the Internet using a personal computer 110. The user then downloads the latest system software to the personal computer 110 through the latest system software upgrade information of the home appliance which is provided from the home appliance company. The downloaded system software is transmitted to the home appliance 100 through a cable 130. The transmitted system software is stored in a flash memory of the home appliance.

However, the method of upgrading the system software of the home appliance using the personal computer as described above has the problem in that the user should connect the personal computer with the home appliance whenever he/she upgrades the software, and this causes the user inconvenience.

Further, it is not easy for the user, who is not familiar with the personal computer, to download the program using the personal computer after he/she manually connects the personal computer with the home appliance. In addition, due to the user's mistake, the home appliance to which the system software is downloaded may not normally operate.

### SUMMARY OF THE INVENTION

Accordingly, the present invention is directed to a method of upgrading system software of a home appliance that substantially obviates one or more problems due to limitations and disadvantages of the related art.

An object of the present invention is to provide a method of upgrading system software of a home appliance which facilitates the upgrade of the system software using a home server.

Another object of the present invention is to provide a method of upgrading system software of a home appliance which facilitates the upgrade of the system software using a home server and a data broadcast propagating from a broadcasting station.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of upgrading system software of a home appliance, includes reading a system software version of the home appliance to be upgraded among home appliances constituting a home network with a home server, reading a latest system software version corresponding to the home appliance from an appliance company server connected through the home server and Internet, comparing the system software version of the home appliance in the home network with the system software version of the corresponding home appliance in the appliance company server, if the system software version of the corresponding home appliance in the appliance company server is newer than the system software version of the home appliance in the home network, downloading the system software of the corresponding home appliance from the appliance company server to the home server, and replacing the system software of the home appliance at home with the downloaded system software through the home network.

In another aspect of the present invention, a method of upgrading system software of a home appliance, includes selecting the system software of the latest home appliance to be updated from a data broadcast which provides upgrade information of the system software of home appliances, downloading the selected system software from an appliance company server to a home server through Internet, and replacing the system software of the home appliance at home with the downloaded system software through the home network.

In still another aspect of the present invention, a method of upgrading system software of a home appliance, includes transmitting the system software of the latest home appliance from an appliance company server to a broadcasting station, propagating a broadcasting stream including the system software, downloading the system software to a home server through a digital television receiver which receives the broadcasting stream, and replacing the system software of the home appliance at home with the downloaded system software through the home network.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating a related art system for implementing a method of upgrading system software of a home appliance;

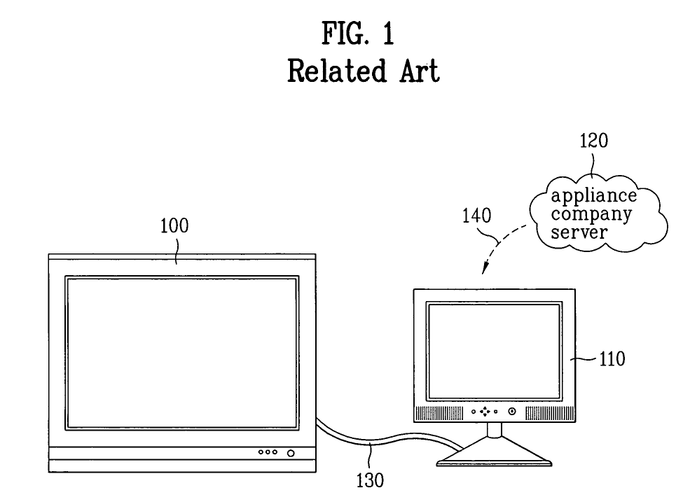

FIG. 2 is a schematic view illustrating a system for implementing a method of upgrading system software of a home appliance according to an embodiment of the present invention;

FIG. 3 is a flowchart illustrating a method of updating system software of a home appliance according to an embodiment of the present invention;

FIG. 4 is a schematic view illustrating a system for implementing a method of updating system software of a home appliance according to another embodiment of the present invention;

FIG. 5 is a flowchart illustrating a method of updating system software of a home appliance according to another embodiment of the present invention;

FIG. 6 is a schematic view illustrating a system for implementing a method of updating system software of a home appliance according to still another embodiment of the present invention; and

FIG. 7 is a flowchart illustrating a method of updating system software of a home appliance according to still another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

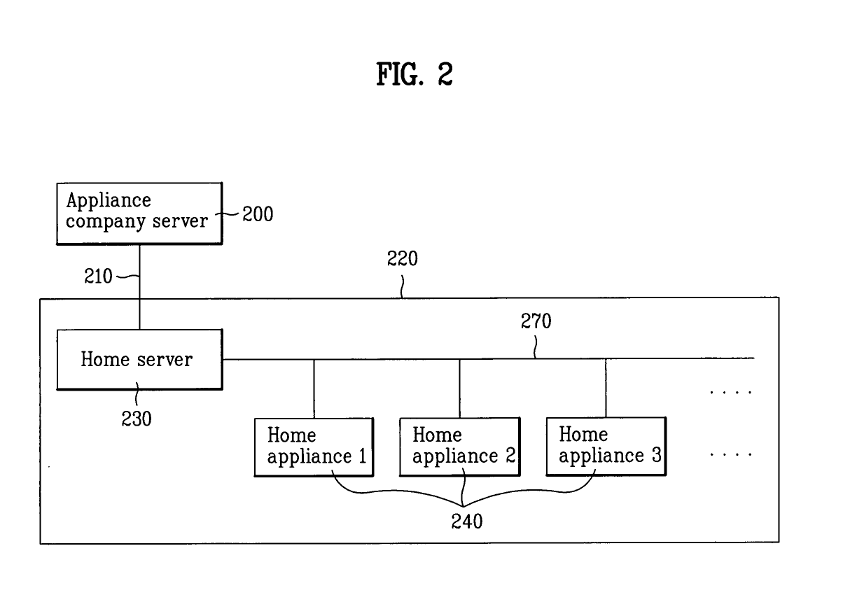

FIG. 2 is a schematic view illustrating a system for implementing a method of upgrading system software of a home appliance according to an embodiment of the present invention.

As shown in FIG. 2, the system for upgrading system software of a home appliance according to the present invention includes an appliance company server 200, a home server 230, and home appliances 240. The appliance company server 200 is connected to the home server through the Internet 210. The home server 230 and the home appliances 240 constitute a home network 220 through a LAN (Local Area Network) 270.

A connection means for constructing the home network 220 may be a wire or wireless interface such as a PLC (Power Line Communication), IEEE1394, home RF (Radio Frequency), Bluetooth, etc.

The home server 230 manages the home network 220, and communicates with the appliance company server 200 and the home appliances 240 in order to provide the latest system software to the home appliances 240. Accordingly, although it is preferable that the home server 230 is a system different from the home appliances 240, a refrigerator which is always in ‘on’ state or a set top box which is connected to the digital television receiver may be the home server 230.

The home appliances 240 may be a television receiver, refrigerator, audio appliance, washing machine, microwave oven, etc. These home appliances 240 include a flash memory for storing the system software.

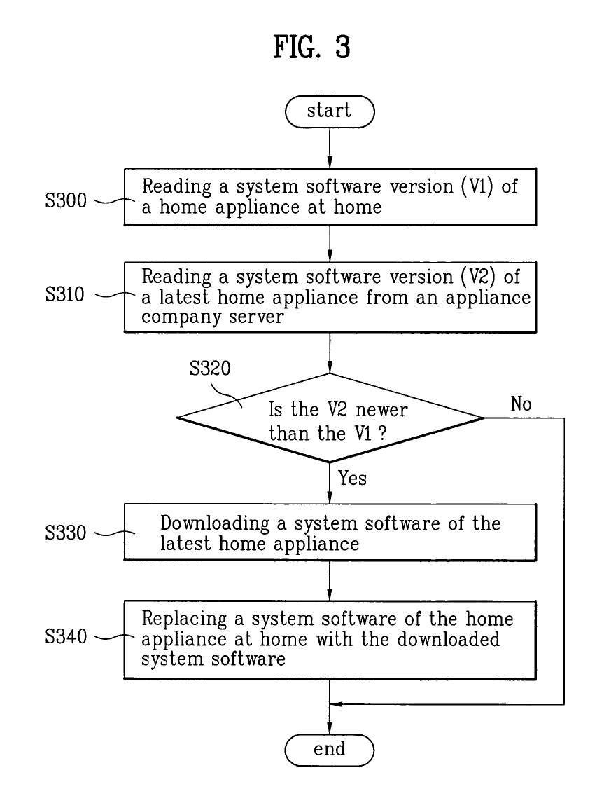

Now, the method of upgrading system software of a home appliance according to an embodiment of the present invention will be explained with reference to FIGS. 2 and 3.

First, the home server 230 reads a system software version of the home appliance to be upgraded among the home appliances 240 (step S300). Simultaneously, the home server 230 reads the latest system software version corresponding to the home appliance 240 from the appliance company server 200 (step S310). It is preferable that the reading operation of the home server 230 is performed at predetermined intervals.

Then, the home server 230 compares the readout system software versions (step S320). If the system software version of the corresponding home appliance 240 in the appliance company server 200 is newer than the system software version of the home appliance 240 in the home network 220 as a result of comparison, the home server 230 downloads the system software of the corresponding home appliance from the appliance company server (step S330).

The home server 230 then replaces the system software of the home appliance 240 at home with the downloaded system software through the home network 220. Through the above-described process, the upgrade of the system software of the home appliance 240 is completed.

Meanwhile, in order to replace the system software of the home appliance 240, the home server 230 may user a TFTP (Trivial File Transfer Protocol) which is a kind of file transfer protocol.

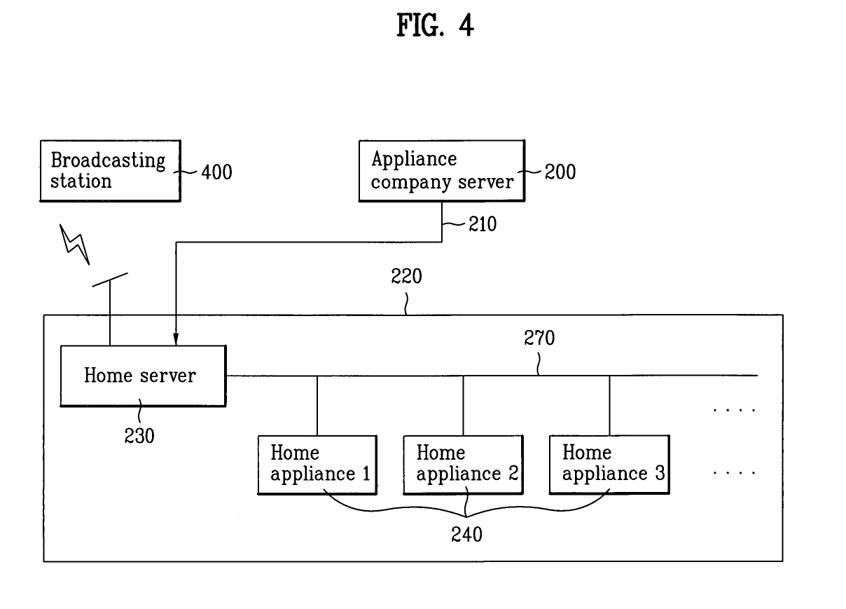

FIG. 4 is a schematic view illustrating a system for implementing a method of updating system software of a home appliance according to another embodiment of the present invention.

As shown in FIG. 4, the system includes a broadcasting station 400, an appliance company server 200, a home server 230, and home appliances 240.

It is preferable that the home server 230 is a set top box (not illustrated) connected to a digital television receiver (not illustrated).

The system of FIG. 4 is identical to the system of FIG. 2 except for the broadcasting station 400. Accordingly, the explanation of the constituent elements which are identical to those of FIG. 2 can also be applied to this embodiment of the present invention.

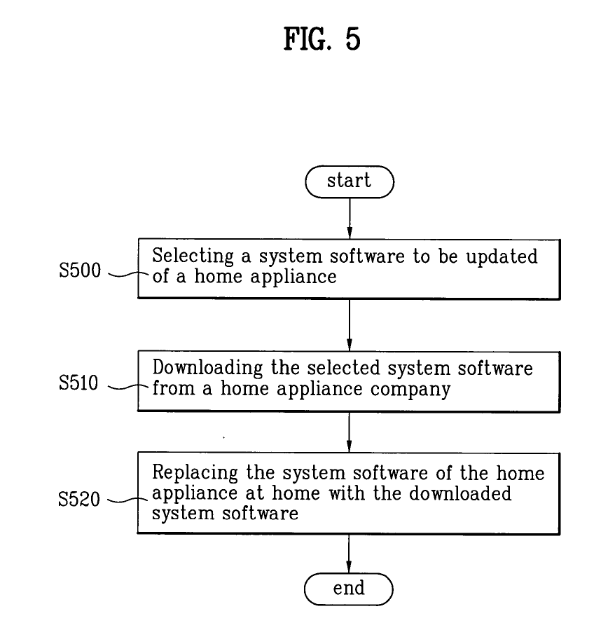

Now, the method of upgrading system software of a home appliance according to another embodiment of the present invention will be explained with reference to FIGS. 4 and 5.

First, a home appliance company (not illustrated) provides information on system software of the latest home appliances to the broadcasting station 400. The broadcasting station 400 provides the system software upgrade information of the home appliances provided from the home appliance company to users through a data broadcasting. The upgrade information includes link information (i.e., Internet address) of the appliance company server 200 which stores the system software of the latest home appliances. The link information is provided in the form of a hypertext on a screen of the digital television receiver (not illustrated) connected to the appliance company server 230. The user who are viewing the data broadcasting selects the system software of the latest home appliance to be updated from the data broadcast by manipulating the home server 230 (step S500).

The home server 230 accesses the appliance company server 200 through the Internet 210 using the link information of the selected system software, and then downloads the selected system software of the latest home appliance from the appliance company server 200 (step S510).

If the download is completed, the home server 230 replaces the system software stored in the flash memory of the corresponding home appliance 240 with the downloaded system software (step S520). Through the above-described process, the upgrade of the system software of the home appliance 240 is completed.

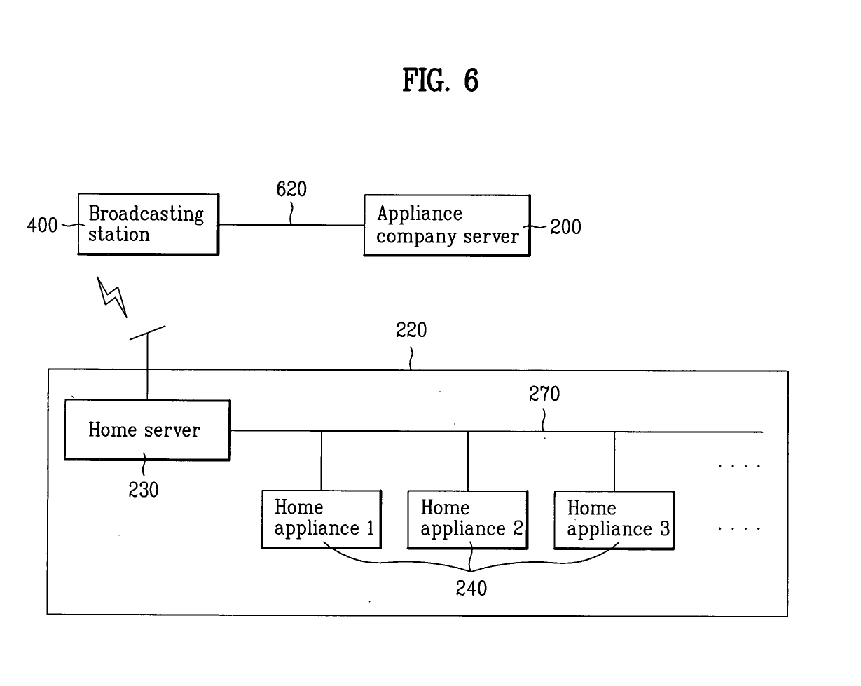

FIG. 6 is a schematic view illustrating a system for implementing a method of updating system software of a home appliance according to still another embodiment of the present invention.

As shown in FIG. 6, the system for upgrading system software of a home appliance according to the present invention includes a broadcasting station 400, an appliance company server 200, a home server 230, and home appliances 240. The appliance company server 200 is connected to the broadcasting station 400 through the Internet 620.

The home server 230 and the home appliances 240 constitute a home network 220 through a LAN 270.

A connection means for constructing the home network 220 may be a wire or wireless interface such as a PLC (Power Line Communication), IEEE1394, home RF (Radio Frequency), Bluetooth, etc.

The home server 230 manages the home network 220. Accordingly, although it is preferable that the home server 230 is a system different from the home appliances 240, a refrigerator which is always in ‘on’ state or a set top box which is connected to the digital television receiver may be the home server 230.

The home appliances 240 may be a television receiver, refrigerator, audio appliance, washing machine, microwave oven, etc. These home appliances 240 include a flash memory for storing the system software.

It is preferable that the home server 230 is connected to the digital television receiver (not illustrated), which receives the latest system software propagating from the broadcasting station 400. Accordingly, it is preferable that the home server 230 is a set top box (not illustrated) connected to the digital television receiver.

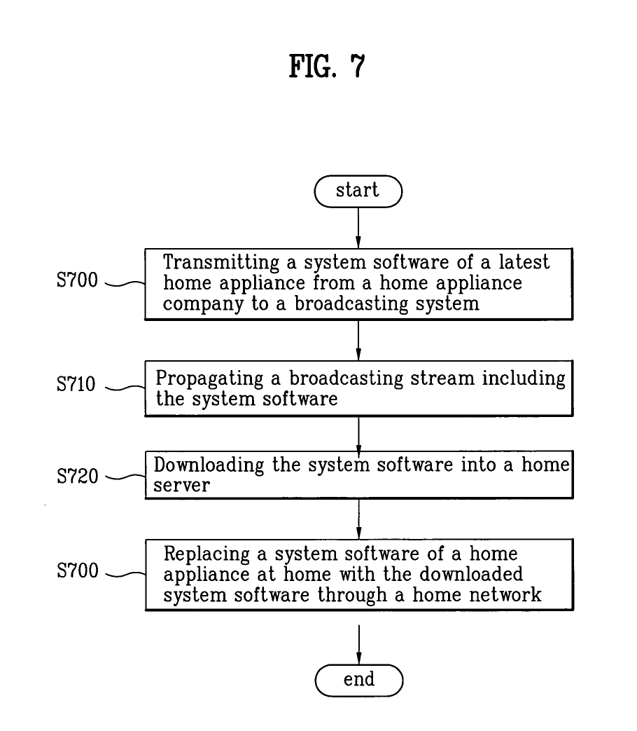

Now, the method of upgrading system software of a home appliance according to still another embodiment of the present invention will be explained with reference to FIGS. 6 and 7.

The appliance company server 200 provides the system software of the latest home appliance to the broadcasting station 400 through the Internet 620 (step S700).

The broadcasting stream, which the broadcasting station 400 transmits through the digital broadcasting, includes data information in addition to the video and audio signals. In the present invention, the data information is the system software of the home appliance. The broadcasting station 400 propagates the broadcasting stream including the system software (step S710).

The digital television receiver (not illustrated) receives the broadcasting stream including the system software of the home appliance from the broadcasting station 400. The home server 230 connected to the digital television receiver extracts and downloads the system software of the home appliance from the broadcasting stream (step s720). The download may start by the selection of the user who views the system software upgrade information of the home appliance. The user's selection may be performed on the screen of the digital television receiver which provides the system software upgrade information of the home appliance in the form of a hypertext.

If the download is completed, the home server 230 replaces the system software of the home appliance at home with the downloaded system software through the LAN 270 (step S730). Through the above-described process, the upgrade of the system software of the home appliance according to the present invention is completed.

It will be apparent to those skilled in the art than various modifications and variations can be made in the present invention. Thus, it is intended that the present invention covers the modifications and variations of this invention provided they come within the scope of the appended claims and their equivalents.

What is claimed is:

1. A method of upgrading system software of a home appliance, comprising:
reading a system software version of the home appliance to be upgraded among home appliances constituting a home network with a home server;
reading a latest system software version corresponding to the home appliance from an appliance company server connected through the home server and Internet;
comparing the system software version of the home appliance in the home network with the system software version of the corresponding home appliance in the appliance company server;
if the system software version of the corresponding home appliance in the appliance company server is newer than the system software version of the home appliance in the home network, downloading the system software of the corresponding home appliance from the appliance company server to the home server; and
replacing the system software of the home appliance at home with the downloaded system software through the home network.

2. The method of claim 1, wherein the step of reading the system software version of the home appliance in the home network is periodically performed.

3. The method of claim 1, wherein the step of reading the system software version of the corresponding home appliance from the appliance company server is periodically performed through the Internet.

4. A method of upgrading system software of a home appliance, comprising:
selecting the system software of the latest home appliance to be updated from a data broadcast which provides upgrade information of the system software of home appliances;
downloading the selected system software from an appliance company server to a home server through Internet; and
replacing the system software of the home appliance at home with the downloaded system software through the home network.

5. The method of claim 4, wherein the home server is a set top box connected to a digital television receiver.

6. A method of upgrading system software of a home appliance, comprising:
transmitting the system software of the latest home appliance from an appliance company server to a broadcasting station through Internet;
propagating a broadcasting stream including the system software;
downloading the system software to a home server through a digital television receiver which receives the broadcasting stream; and
replacing the system software of the home appliance at home with the downloaded system software through the home network.

7. The method of claim 6, wherein the home server is a set top box connected to the digital television receiver.
